(19) United States
(12) Patent Application Publication
(10) Pub. No.: US 2008/0103251 A1
(43) Pub. Date: May 1, 2008

(54) Polyurethanes

(75) Inventors: John Patrick O' Donnell, Manchester (GB); Mark Walker, Manchester (GB); Stephen George Yeates, Manchester (GB)

Correspondence Address: MORGAN LEWIS & BOCKIUS LLP, 1111 PENNSYLVANIA AVENUE NW, WASHINGTON, DC, 20004, US

(73) Assignee: FUJIFILM IMAGING COLORANTS LIMITED, Blackley, Manchester (GB)

(21) Appl. No.: 11/661,547

(22) PCT Filed: Aug. 15, 2005
(86) PCT No.: PCT/GB05/03192

§ 371 Date: Mar. 1, 2007

(30) Foreign Application Priority Data
Sep. 10, 2004 (GB) 0420112.5

(51) Int. Cl. C08L 75/04

(52) U.S. Cl. 524/590; 525/453

(57) ABSTRACT

A process for the preparation of a water-dissipatable polyurethane comprising preparation of a polyurethane prepolymer, reacting the polyurethane prepolymer with a mono functional end-capping agent to give a partially end capped polyurethane prepolymer and chain extending the partially end capped polyurethane prepolymer to give the water-dissipatable polyurethane. The polyurethanes are useful in ink jet printing.

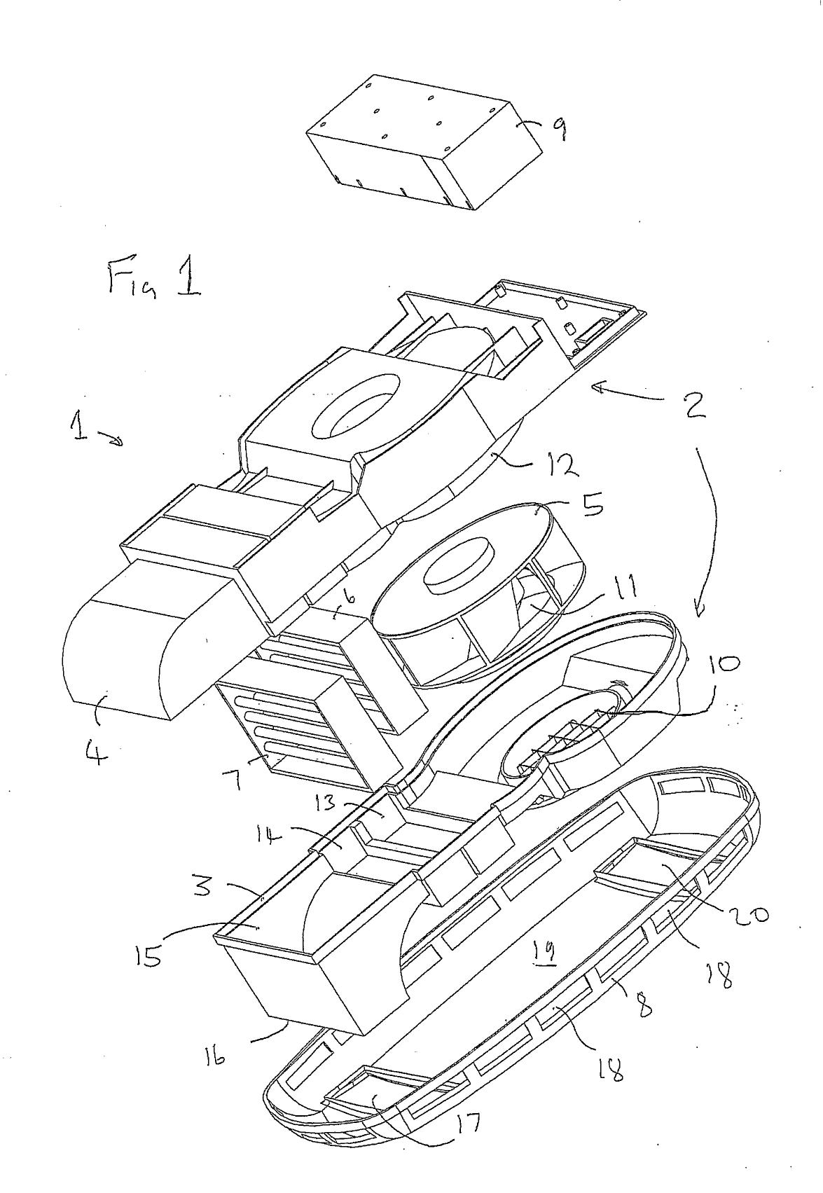

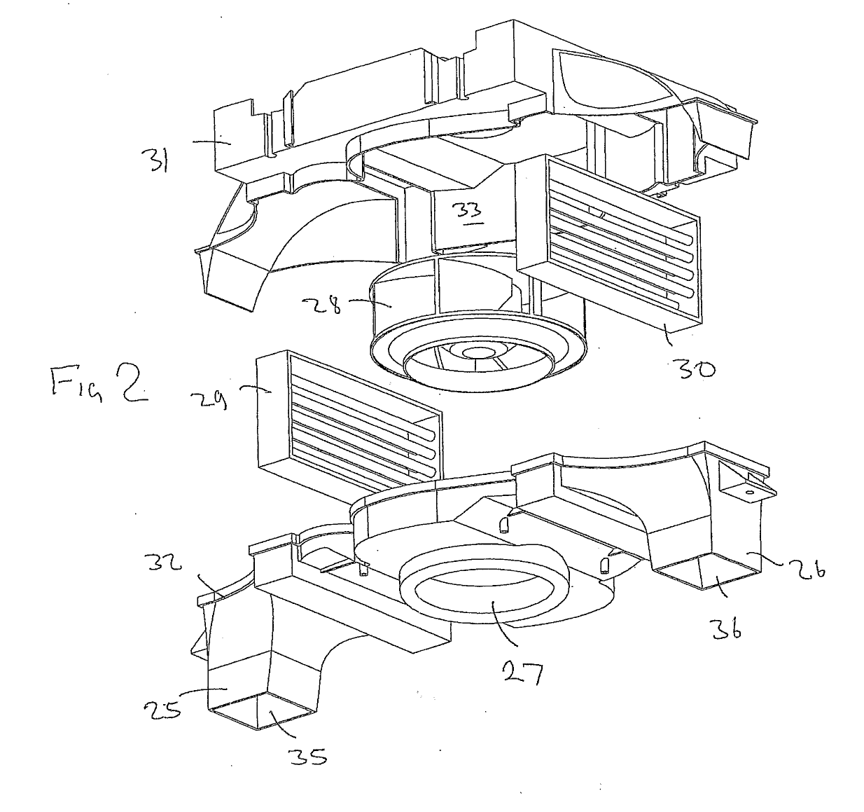

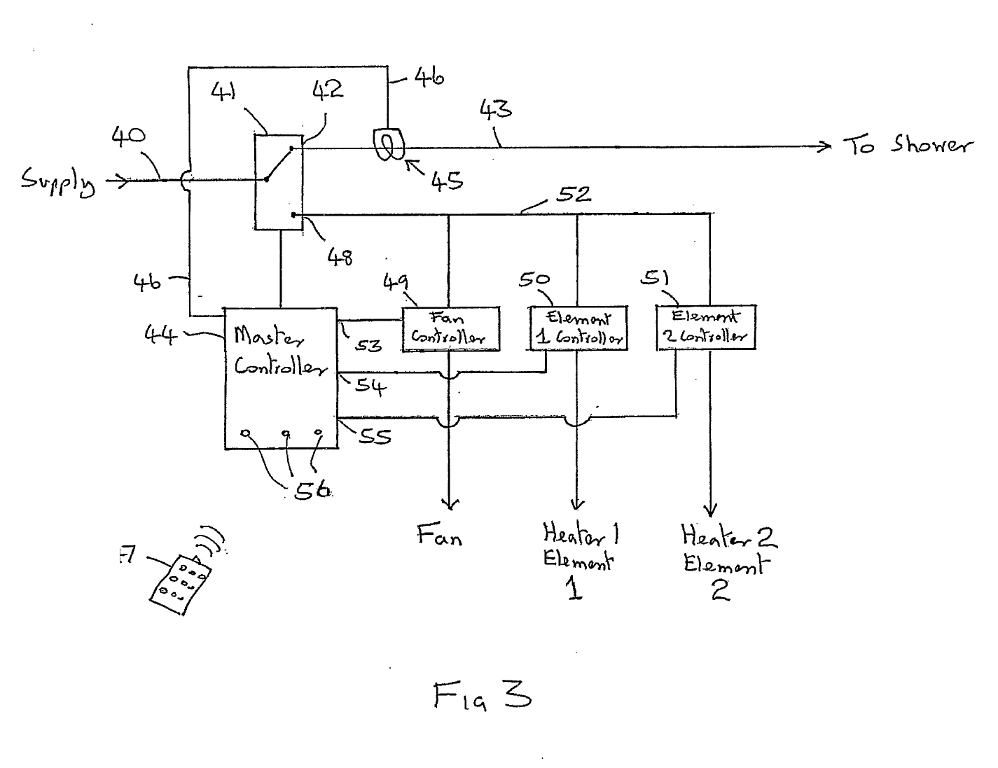

This invention relates to processes for making water-dissipatable polyurethanes and to the products of such processes.

Water-dissipatable polyurethanes and their use in ink jet printing inks are known. For example WO 99/50634 describes ink jet compositions containing water-dissipatable polyurethanes.

Typically polyurethanes are prepared by reacting a polyisocyanate with a polyol. The molecular weight of the ultimate polyurethane may be controlled by end capping with, for example, a mono alcohol or mono amine. The end capping group prevents the polyurethane from increasing in molecular weight by terminating (i.e. ‘end capping’) polymerisable end groups of the polyurethane. Alternatively the molecular weight of the polyurethane may be increased dramatically by reaction with a chain extender, e.g. a diamine or hydrazine, thereby causing polyurethane molecule to double, treble etc. in molecular weight through attachment to the chain extender.

The present invention relates to a method for making water-dissipatable polyurethanes involving a combination of partial end capping followed by chain extension. We have found such polyurethanes are particularly useful for ink jet printing applications.

According to a first aspect of the present invention there is provided a process for the preparation of a water-dissipatable polyurethane comprising preparation of a polyurethane prepolymer, reacting the polyurethane prepolymer with a mono functional end capping agent to give a partially end capped polyurethane prepolymer and chain extending the partially end capped polyurethane prepolymer to give the water-dissipatable polyurethane.

The polyurethane prepolymer may be obtained from the reaction of a mixture comprising the components:

i) at least one polyisocyanate; and

ii) at least one compound having at least two isocyanate-reactive groups.

The polyurethane prepolymer may be prepared by reacting components i) and ii) in a conventional manner. Substantially anhydrous conditions are preferred. Temperatures of from 30° C. and 130° C. are preferred and the reaction is continued until the reaction between isocyanate groups in component i) and the isocyanate-reactive groups in component ii) is substantially complete.

The relative amounts of components i) and ii) are preferably selected such that the mole ratio of isocyanate groups to isocyanate-reactive groups is from 2:1 to 1.2:1, more preferably 1.3:1 to 2:1 and especially from 1.4:1 to 2:1. As a result the polyurethane prepolymer preferably has an NCO/OH ratio of 2:1 to 1.2:1, more preferably 1.3:1 to 2:1 and especially from 1.4:1 to 2:1.

The polyurethane prepolymer may be prepared, for example, in solvent or as a melt.

If desired a catalyst may be used to assist formation of the polyurethane prepolymer. Suitable catalysts include butyl tin dilaurate, stannous octoate and tertiary amines as known in the art.

In a preferred embodiment the process either does not use a catalyst or the process uses a metal-free catalyst. This embodiment has the advantage of avoiding contamination of the resultant polyurethane with metal from a metal-containing catalyst. Metals such as those commonly used in catalysts can adversely affect ink jet printheads, particularly those used in thermal ink jet printers.

In one aspect the present invention provides the use of a water-dissipatable polyurethane in an ink jet printing ink wherein the polyurethane has been obtained by a process free from metal-containing catalysts. Preferably the ink is an ink jet printing ink intended for use in a thermal ink jet printer. Preferably the polyurethane has been obtained by a process according to the first aspect of the present invention which is does not use a catalyst or uses a metal-free catalyst.

Component i) may be any polyisocyanate having two or more isocyanate groups, for example an aliphatic, cycloaliphatic, aromatic or araliphatic polyisocyanate. Examples of suitable polyisocyanates include ethylene diisocyanate, 1,6-hexamethylene diisocyanate, isophorone diisocyanate, tetramethylxylene diisocyanate, 1,4-phenylene diisocyanate, 2,4-toluene diisocyanate, 2,6-toluene diisocyanate, 4,4′-diphenyl-methane diisocyanate and its hydrogenated derivative, 2,4′-diphenylmethane diisocyanate and its hydrogenated derivative, and 1,5-naphthylene diisocyanate. Mixtures of the polyisocyanates can be used, particularly isomeric mixtures of the toluene diisocyanates or isomeric mixtures of the diphenylmethane diisocyanates (or their hydrogenated derivatives), and also organic polyisocyanates which have been modified by the introduction of urethane, allophanate, urea, biuret, carbodiimide, uretonimine or isocyanurate residues.

Preferred polyisocyanates include cycloaliphatic polyisocyanates, especially isophorone diisocyanate, and aliphatic isocyanates, especially 1,6-hexamethylene diisocyanate or hydrogenated 4,4-diphenyl methyl diisocyanate.

A small quantity of tri- or higher-isocyanates may be included as part of component i) but this amount preferably does not exceed 5% by weight relative to the total weight of component i). In a preferred embodiment component i) consists of a mixture of diisocyanate and from 0 to 5% (preferably 0%) of tri- or higher-isocyanate by weight relative to the diisocyanate.

With reference to component ii), preferred isocyanate-reactive groups are selected from —OH, —NH₂, —NH— and —SH. Isocyanate-reactive compounds having three isocyanate-reactive groups may be present, preferably in low levels not exceeding 5% by weight relative to the total weight of component ii). These isocyanate-reactive groups are capable of reacting with an isocyanate (—NCO) group in component i).

Dispersing groups may be present in component i) or, more preferably, component ii). Such groups can be incorporated to help make the final polymer water-dissipatable. The dispersing groups provide the facility of self-dispersibility or solubility to the polyurethane in ink media, especially in water. The dispersing groups may be ionic, non-ionic or a mixture of ionic and non-ionic dispersing groups. Preferred ionic dispersing groups include cationic quaternary ammonium groups, sulphonic acid groups and carboxylic acid groups.

The ionic dispersing groups may be incorporated into the polyurethane in the form of a low molecular weight polyol or polyamine bearing the appropriate ionic dispersing groups. Preferred isocyanate-reactive compounds providing dispersing groups are diols having one or more carboxylic acid groups, more preferably dihydroxy alkanoic acids, especially 2,2-dimethylol propionic acid.

The carboxylic and sulphonic acid groups may be subsequently fully or partially neutralised with a base or compound containing a cationic charge to give a salt. If the carboxylic or sulphonic acid groups are used in combination with a non-ionic dispersing group, neutralisation may not be required. The conversion of any free acid groups into the corresponding salt may be effected during the preparation of the polyurethane and/or during the preparation of an ink from the polyurethane.

Preferably the base used to neutralise any acid dispersing groups is ammonia, an amine or an alkaline metal base. Suitable amines are tertiary amines, for example triethylamine or triethanolamine. Suitable alkaline metal bases include alkaline metal hydroxides and carbonates, for example lithium hydroxide, sodium hydroxide, or potassium hydroxide. A quaternary ammonium hydroxide, for example N⁺(CH₃)₄OH⁻, can also be used. Generally a base is used which gives the required counter ion desired for the ink which is prepared from the polyurethane. For example, suitable counter ions include Li⁺, Na⁺, K⁺, NH₄⁺ and substituted ammonium salts.

Non-ionic dispersing groups may be in-chain or pendant groups. Preferably non-ionic dispersing groups are pendant polyoxyalkylene groups, more preferably polyoxyethylene groups. The non-ionic groups may be introduced into the polyurethane in the form of a compound bearing non-ionic dispersing groups and at least two isocyanate-reactive groups.

Preferably component ii) is a polyalkylene glycol having an Mn of 500 to 3000.

The nature and level of dispersing groups in the polyurethane prepolymer influences whether a solution, dispersion, emulsion or suspension is formed on dissipation of the final water-dissipatable polyurethane.

The partially end capped polyurethane prepolymer may be prepared by reacting the polyurethane prepolymer having isocyanate end groups with a mono functional end-capping agent, e.g. a mono hydrazide, mono thiol, mono alcohol and/or a mono amine. Preferably a solvent comprising or consisting of tetramethyl sulphone and/or acetone is used. Temperatures of 20 to 110° C. are preferred, especially 30 to 90° C. The reaction time will depend on the desired degree of end-capping.

Mono alcohols suitable for partial end capping the polyurethane prepolymer include C₁₋₆-mono alcohols (e.g. methanol, ethanol, propanol, butanol and hexanol) and C₁₋₆-alkyl ethers of glycols (e.g. ethylene, propylene or butylene glycol ethers) and glycol esters, e.g. ethylene, propylene or butylene glycol esters and especially diethylene glycol monomethyl ether and triethylene glycol monomethyl ether.

Mono amines suitable for partial end capping the polyurethane prepolymer include primary and secondary amines, especially amines having one or two C₁₋₄-alkyl groups (e.g. methylamine, dimethylamine, ethylamine, diethylamine, propylamine, dipropylamine, butylamine and cyclohexylamine). Mixtures of mono alcohols, mixtures of mono amines and mixtures of mono alcohols with mono amines may also be used for partial end-capping.

Partial end-capping may be achieved by reaction of the polyurethane prepolymer with less than a 100% stoichiometric amount of the mono functional end-capping agent.

Preferably reaction of the polyurethane prepolymer with the mono alcohol and/or mono amine results in a polyurethane prepolymer which is 5 to 95% end-capped, more preferably 5 to 75% end-capped and especially 5 to 60% end-capped. In another embodiment the polyurethane prepolymer is 1 to 10% end-capped.

The extent of partial end-capping may be measured by determination of the residual end-group (e.g. isocyanate) value of the polyurethane prepolymer before and after end-capping and dividing the former by the latter and multiplying by 100%. For example:

$$\% end capping = 100 \% \times \% \frac{\begin{matrix}NCO Value of end capped \\ polyurethane prepolymer\end{matrix} }{\begin{matrix}NCO Value of polyurethane \\ prepolymer before end \text{-} capping\end{matrix} } .$$

The chain extension is preferably performed in aqueous medium. Temperatures of 5 to 80° C., more preferably 15 to 60° C. are preferred. The time for which the chain extension is conducted depends to some extent of the Mn required for the water-dissipatable polymer.

Diamino compounds which may be used for chain-extension are preferably aliphatic, saturated, open-chain or cyclic diamines with 2 to 10 carbon atoms; e.g. cyclohexylenediamine, isophoronediamine, ethylenediamine, propylene-1,2- or -1,3-diamine, hexamethylenediamine and 2,2,4- and/or 2,4,4-trimethylhexylene-1,6-diamine, among which the lower molecular open-chain diamines with 2 to 6 carbon atoms, in particular propylene-1,3-diamine and propylene-1,2-diamine, and isophoronediamine are preferred, or even hydrazine, the latter being preferably employed in the form of the hydrate.

The chain extension is conducted in such a way that the desired Mn for the final product is achieved. One may assess whether the desired Mn has been achieved by Gel permeation chromatography (“GPC”). If desired for chain extension there may be employed a preferably simple diol instead of the diamino compound, e.g. a C₂₋₆-alkane diol. Examples of suitable diols include trimethylene glycol, ethanediol, 1,6-hexanediol, neopentylglycol, diethylene glycol, dipropylene glycol, 1,4-butanediol, 1,2-propylene glycol, 1,4-cyclohexanediamethylol, 1,4-cyclohexanediol, 1,4-bis(2-hydroxyethoxy) benzene, bis(2-hydroxyethyl)terephthalante, paraxylylenediol, and mixtures of two or more thereof.

Chain extension is preferably performed using hydrazine and/or a diamine.

The water-dissipatable polyurethane preferably has a number average molecular weight (Mn) below 15,000 because this can lead to an improved performance of inks containing the polyurethane, especially for use in thermal ink jet printers. The Mn of the water-dissipatable polyurethane is preferably from 1,000 to 15,000, more preferably from 2,000 to 12,000 and especially from 3,000 to 10,000. Mn may be measured by GPC.

The GPC method used for determining Mn preferably comprises applying a solution of the polyurethane to a chromatography column packed with cross-linked polystyrene/divinyl benzene, eluting the column with tetrahydrofuran at a temperature of 40° C. and assessing the Mn of the polyurethane compared to a number of a polystyrene standards of a known Mn. Suitable cross-linked polystyrene/divinyl benzene chromatography columns are commercially available from Polymer Laboratories.

If the gpc method for determining Mn does not work for any reason then other methods to determine Mn may be used, for example multiple angle laser scattering.

The water-dissipatable polyurethane preferably has a weight average molecular weight (Mw) of 20,000 to 500,000, more preferably 50,000 to 300,000. At Mw above 500,000 inks containing the water-dissipatable polyurethane can become overly viscous. At Mw below 20,000 inks containing the water-dissipatable polyurethane can show reduced rub-fastness.

The dispersing group content of the water-dissipatable polyurethane may vary within wide limits but is preferably sufficient to make the polyurethane form stable ink-jet printing inks in water and aqueous media. The water-dissipatable polyurethane is preferably soluble in water, although minor amount of the water-dissipatable polyurethane may be insoluble in water and exist as dissipated particles when mixed with aqueous media or water.

The polyurethane of the present invention may be purified if desired in the usual way for colorants used in ink jet printing inks. For example a mixture of the polyurethane and water may be purified by ion-exchange, filtration, reverse osmosis, dialysis, ultra-filtration or a combination thereof. In this way one may remove co-solvents used for the polymerisation, low molecular weight salts, impurities and free monomers.

Preferably the water-dissipatable polyurethane has an acid value>20 mg KOH/g and <100 mg KOH/g.

Preferably the water-dissipatable polyurethane has a calculated log P of −0.5 to +2.0.

Preferably the water-dissipatable polyurethane contains from 10 to 40% by weight of poly(alkylene oxide) groups.

Taking account of the above preferences, in a preferred process according to the first aspect of the present invention:
(a) the end capping is performed in tetramethyl sulpholane using a polyalkylene glycol monoC₁₋₄-alkyl ether having a molecular weight below 300;
(b) the chain extension is performed using a C₂₋₄-alkylene diamine;
(c) the polyol is a polypropylene glycol having an Mn of 500 to 3000;
(d) the polyisocyanate is isophorone diisocyanate; and
(e) the water-dissipatable polymer has an Mn below 15,000, an acid value>20 mg KOH/g and <100 mg KOH/g and a log P of −0.5 to +2.0.

According to a second aspect of the present invention there is provided a water-dissipatable polyurethane obtainable or obtained by a process according to the first aspect of the present invention.

The polyurethanes of this invention may be used for a number of purposes, including but not limited to the preparation of ink jet printing inks. The polyurethanes can be used to make stable inks, providing good print performance and desirable properties for the final, printed image. For example, the polyurethanes can be used as a binder in pigment-based inks as described in U.S. Pat. No. 6,908,185.

According to a third aspect of the present invention there is provided an ink comprising 0.1 wt % to 10 wt %, more preferably 0.5 wt % to 5 wt %, of a polyurethane obtained by the process of the present invention.

Preferably the ink is for ink jet printing. The pH of the ink is preferably from 4 to 11, more preferably from 7 to 10. The viscosity of the ink at 25° C. is preferably less than 50 cP, more preferably less than 20 cP and especially less than 5 cP. Preferably the ink contains water and organic solvent. Preferably the ink contains a pigment.

The invention will now be described by example only. All parts and percentages are by weight unless specified otherwise. In the following examples:
1. DMPA is obtained in pellet form and is milled to a free flowing powder in a metal bladed “food blender” before use.
2. Sulfolane is a low melting point solid and is melted at 30° C. prior to use (usually stored in an oven overnight).
3. The moisture content of PPG 1000 and sulfolane were as follows (determined by Karl Fisher method):
   a. PPG 1000—0% (none detected)
   b. Sulfolane—0.063% (moisture content for ‘non-dried’ material=0.18%)
      (Both materials were dried before use using activated molecular sieves before use).
4. Tri(propylene glycol)methyl ether contained 0.11% water (not dried before use).

### EXAMPLE 1

The following ingredients were used in this example:

| | | | | | Weight | | Weight |
|---|---|---|---|---|---|---|---|
| | | | | | percent | | percent |
| | component | abbreviation | functionality | mol wt | (Solids) | Lab scale/g | (total) |
| 1 | Polypropylene | PPG1000 | 2 | 1000 | 31.86 | 572.47 | 8.088 |
| | glycol 1000 | | | | | | |
| 2 | Dimethylol | DMPA | 2 | 134.13 | 13.36 | 240.00 | 3.391 |
| | propionic acid | | | | | | |
| 3 | Tetramethylene | Sulfolane | | | — | 400.00 | 5.651 |
| | Sulfone | | | | | | |
| 4 | Isophorone | IPDI | 2 | 222.29 | 43.82 | 787.53 | 11.127 |
| | diisocyanate | | | | | | |
| 5 | Dibutyltin dilaurate | DBTDL | | | — | 1.60 | — |
| 6 | Tri(propylene | TPGME | 1 | 206.29 | 9.84 | 176.55 | 2.494 |
| | glycol) mono | | | | | | |
| | methyl ether | | | | | | |
| 7 | Dibutyltin dilaurate | DBTDL | | | — | 0.60 | — |
| 8 | Tetramethylene | Sulfolane | | | — | 285.29 | 4.031 |
| | Sulfone | | | | | | |
| 9 | Hydrazine | Hydrazine | 2 | 50.06 | 1.12 | 28.255 | 0.399 |
| | Monohydrate | | | | | | |
| 10 | Aq Potassium | Aq KOH | | | — | 986.41 | 13.936 |
| | Hydroxide (10%) | | | | | | |
| 11 | Deionised water | | | | — | 3601.42 | 50.883 |
| | Totals | | | | 100.00 | | 100.000 |

### Stage 1—Preparation of a Polyurethane Prepolymer

A five litre round-bottomed reactor was fitted with a mechanical paddle stirrer, thermocouple and a water-cooled condenser. The following steps were performed under a nitrogen blanket. Components 1, 2 and 3 were charged to the reactor at 19-22° C., followed by component 4, which was added with stirring. The reactor was heated by an external isomantal to 47-50° C. for about 10 minutes whilst maintaining a nitrogen blanket. Component 5 was then added. The reaction mixture was then warmed to 95° C. over about 5 minutes. At 95° C. an exotherm is observed and this is controlled using an external ice bath. The reactor was then maintained at 95° C. for a further 2.5 hours after which a sample was removed for NCO determination via titration to check complete reaction by comparing theoretical with experimental NCO value (experimental value 4.5% and theoretical value 4.6%).

### Stage 2—Partial End-Capping of the Polyurethane Prepolymer

Component 6 was added to the reactor through a pressure equalizing dropping funnel, followed by Component 7 (slight exotherm observed). The reactor was then maintained at 95° C. for a further 75 minutes after which component 8 was added. A sample was extracted for NCO determination via titration. The extent of end-capping was 49%.

### Stage 3—Chain Extending the Partially End-Capped Polyurethane Prepolymer

The partially end-capped polyurethane prepolymer arising from stage 2 (2203.6 g, 90-95° C.) was then dispersed into a 10 litre baffled round-bottomed reactor containing components 9, 10 and 11 (temperature of 30° C.). Agitation was maintained throughout the addition and for several hours afterwards. The temperature during the dispersion of the prepolymer is kept <40° C. by the use of an external ice bath. After ensuring that the pH was in the range 8 to 9, the mixture was filtered through a 52 micron cloth to give the desired water-dissipatable polyurethane having a pH of 8.3, a solids content of 24.4% and a viscosity of 70.8 mPa·s. (Brookfield, spindle2, 100 rpm, 21° C.).

The desired water-dissipatable polyurethane comprised the residues of DMPA (13.36%), PPG 1000 (31.86%), IPDI (43.82%), TPGME (9.84%) and hydrazine (1.12%).

### EXAMPLE 2

The following ingredients were used in this example:

| | | | | | Weight | | Weight |
|---|---|---|---|---|---|---|---|
| | | | | | percent | | percent |
| | component | abbreviation | functionality | mol wt | (Solids) | Lab scale/g | (total) |
| 1 | Polypropylene | PPG1000 | 2 | 1000 | 31.20 | 107.67 | 7.94 |
| | glycol 1000 | | | | | | |
| 2 | Dimethylol | DMPA | 2 | 134.13 | 13.04 | 45.00 | 3.32 |
| | propionic acid | | | | | | |
| 3 | Tetramethylene | Sulfolane | | | — | 128.57 | 9.48 |
| | Sulfone | | | | | | |
| 4 | Isophorone | IPDI | 2 | 222.29 | 42.69 | 147.33 | 10.86 |
| | diisocyanate | | | | | | |
| 5 | Tin Octoate | Tin Octoate | | | — | 0.04 | — |
| | (Jeffcat T9) | | | | | | |
| 6 | Tri(propylene | TPGME | 1 | 206.29 | 12.05 | 41.14 | 3.03 |
| | glycol) mono | | | | | | |
| | methyl ether | | | | | | |
| 7 | Tin Octoate | Tin Octoate | | | — | 0.04 | — |
| | (Jeffcat T9) | | | | | | |
| 8 | Ethylene Diamine | EDA | 2 | 60.1 | 1.02 | 3.230 | 0.24 |
| 9 | Sodium Hydroxide | NaOH | | 40.0 | — | 13.50 | 1.00 |
| 10 | Deionised water | | | | — | 869.79 | 64.13 |
| | Totals | | | | 100.00 | | 100.00 |

### Stage 1—Preparation of a Polyurethane Prepolymer

A one litre round-bottomed reactor was fitted with a mechanical paddle stirrer, thermocouple and a water-cooled condenser. The following steps were performed under a nitrogen blanket.

Components 1, 2 and 3 were charged to the reactor at 19-22° C., followed by component 4, which was added with stirring. The reactor was heated by an external isomantal to 47-50° C. for about 10 minutes whilst maintaining a nitrogen blanket. Component 5 was then added. The reaction mixture was then warmed to 95° C. over about 5 minutes. At 95° C. an exotherm is observed and this is controlled using an external ice bath. The reactor was then maintained at 95° C. for a further two hours after which a sample was removed for NCO determination via titration to check complete reaction by comparing theoretical with experimental NCO value (experimental value 4.20% and theoretical value 4.30%).

### Stage 2—Partial End-Capping of the Polyurethane Prepolymer

Component 6 was added to the reactor through a pressure equalizing dropping funnel, followed by Component 7 (slight exotherm observed). The reactor was then maintained at 95° C. for a further 60 minutes. A sample was extracted for NCO determination via titration. The extent of end-capping was 47%.

### Stage 3—Chain Extending the Partially End-Capped Polyurethane Prepolymer

The partially end-capped polyurethane prepolymer arising from stage 2 (432.1 g, 75-80° C.) was then dispersed into a three litre baffled round-bottomed reactor containing components 8, 9 and 10 (temperature of 25° C.). Agitation was maintained throughout the addition and for several hours afterwards. The temperature during the dispersion of the prepolymer is kept <40° C. by the use of an external ice bath. After ensuring that the pH was in the range 8 to 9, the mixture was filtered through a 52 micron cloth to give the desired water-dissipatable polyurethane having a pH of 9.07, a solids content of 24.55%.

The desired water-dissipatable polyurethane comprised the residues of DMPA (13.04%), PPG 1000 (31.20%), IPDI (42.69%), TPGME (12.05%) and EDA (1.02%). The molecular weight of the desired water-dissipatable polyurethane was determined by gel permeation chromatography and had Mw=27,800 and Mn=15,600.

### EXAMPLE 3

The following ingredients were used in this example:

| | | | | | Weight | | Weight |
|---|---|---|---|---|---|---|---|
| | | | | | percent | Lab | percent |
| | component | abbreviation | functionality | mol wt | (Solids) | scale/g | (total) |
| 1 | Polypropylene | PPG1000 | 2 | 1000 | 33.95 | 107.67 | 13.00 |
| | glycol 1000 | | | | | | |
| 2 | Dimethylol | DMPA | 2 | 134.13 | 14.19 | 45 | 5.43 |
| | propionic acid | | | | | | |
| 3 | Tetramethylene | Sulfolane | | | — | 161.54 | 19.51 |
| | Sulfone | | | | | | |
| 4 | Isophorone | IPDI | 2 | 222.29 | 46.46 | 147.33 | 17.79 |
| | diisocyanate | | | | | | |
| 5 | Tin Octoate | Tin Octoate | | | — | 0.04 | — |
| | (Jeffcat T9) | | | | | | |
| 6 | Tri(propylene | TPGME | 1 | 206.29 | 1.98 | 6.23 | 0.75 |
| | glycol) mono | | | | | | |
| | methyl ether | | | | | | |
| 7 | Tin Octoate | Tin Octoate | | | — | 0.03 | — |
| | (Jeffcat T9) | | | | | | |
| 8 | Triethylamine | TEA | | 101.19 | — | 15.24 | 1.84 |
| 9 | Deionised water | | | | — | 335.49 | 40.51 |
| 10 | Ethylene Diamine | EDA | 2 | 60.1 | 3.41 | 4.871 | 0.59 |
| 11 | Deionised water | | | | — | 4.8 | 0.58 |
| | Totals | | | | 100.00 | | 100.00 |

### Stage 1—Preparation of a Polyurethane Prepolymer

A one litre round-bottomed reactor was fitted with a mechanical paddle stirrer, thermocouple and a water-cooled condenser. The following steps were performed under a nitrogen blanket.

Components 1, 2 and 3 were charged to the reactor at 19-22° C., followed by component 4, which was added with stirring. The reactor was heated by an external isomantal to 47-50° C. for about 10 minutes whilst maintaining a nitrogen blanket. Component 5 was then added. The reaction mixture was then warmed to 95° C. over about 5 minutes. At 95° C. an exotherm is observed and this is controlled using an external ice bath. The reactor was then maintained at 95° C. for a further two hours after which a sample was removed for NCO determination via titration to check complete reaction by comparing theoretical with experimental NCO value (experimental value 3.7% and theoretical value 4.0%).

### Stage 2—Partial End-Capping of the Polyurethane Prepolymer

Component 6 was added to the reactor through a pressure equalizing dropping funnel, followed by Component 7 (slight exotherm observed). The reactor was then maintained at 95° C. for a further 60 minutes. A sample was extracted for NCO determination via titration. The extent of end-capping was 7.5%.

### Stage 3—Chain Extending the Partially End-Capped Polyurethane Prepolymer

The partially end-capped polyurethane prepolymer arising from stage 2 (210.6 g, 75-80° C.) was then dispersed into a three litre baffled round-bottomed reactor containing components 8 and 9 (temperature of 25° C.). Agitation was maintained throughout the addition. After ten minutes, a solution of component 10 and component 11 was added drop-wise. Agitation was then maintained for several hours afterwards. The temperature during the dispersion of the prepolymer is kept <40° C. by the use of an external ice bath. After ensuring that the pH was in the range 8 to 9, the mixture was filtered through a 52 micron cloth to give the desired water-dissipatable polyurethane having a pH of 9.43, a solids content of 25.16%.

The desired water-dissipatable polyurethane comprised the residues of DMPA (14.19%), PPG 1000 (33.95%), IPDI (46.46%), TPGME (1.98%) and EDA (3.41%). The molecular weight of the desired water-dissipatable polyurethane was determined by gel permeation chromatography and had Mw=65,200 and Mn=29,200.

### EXAMPLE 4

The following ingredients were used in this example:

| | | | | | Weight | | Weight |
|---|---|---|---|---|---|---|---|
| | | | | | percent | | percent |
| | component | abbreviation | functionality | mol wt | (Solids) | Lab scale/g | (total) |
| 1 | Polypropylene | PPG1000 | 2 | 1000 | 34.55 | 107.67 | 11.98 |
| | glycol 1000 | | | | | | |
| 2 | Dimethylol | DMPA | 2 | 134.13 | 14.44 | 45 | 5.00 |
| | propionic acid | | | | | | |
| 3 | Tetramethylene | Sulfolane | | | — | 161.54 | 17.97 |
| | Sulfone | | | | | | |
| 4 | Isophorone | IPDI | 2 | 222.29 | 47.28 | 147.33 | 16.39 |
| | diisocyanate | | | | | | |
| 5 | Tin Octoate | Tin Octoate | | | — | 0.04 | — |
| | (Jeffcat T9) | | | | | | |
| 6 | Tri(propylene | TPGME | 1 | 206.29 | 2.07 | 6.40 | 0.71 |
| | glycol) mono | | | | | | |
| | methyl ether | | | | | | |
| 7 | Tin Octoate | Tin Octoate | | | — | 0.03 | — |
| | (Jeffcat T9) | | | | | | |
| 8 | Ethylene Diamine | EDA | 2 | 60.1 | 1.66 | 2.4302 | 0.27 |
| 9 | Ammonia | Aq NH3 | | | — | 8.43 | 0.94 |
| | soln.(35%) | | | | | | |
| 10 | Deionised water | | | | — | 420.21 | 46.74 |
| | Totals | | | | 100.00 | | 100.00 |

### Stage 1—Preparation of a Polyurethane Prepolymer

A one litre round-bottomed reactor was fitted with a mechanical paddle stirrer, thermocouple and a water-cooled condenser. The following steps were performed under a nitrogen blanket.

Components 1, 2 and 3 were charged to the reactor at 19-22° C., followed by component 4, which was added with stirring. The reactor was heated by an external isomantal to 47-50° C. for about 10 minutes whilst maintaining a nitrogen blanket. Component 5 was then added. The reaction mixture was then warmed to 95° C. over about 5 minutes. At 95° C. an exotherm is observed and this is controlled using an external ice bath. The reactor was then maintained at 95° C. for a further two hours after which a sample was removed for NCO determination via titration to check complete reaction by comparing theoretical with experimental NCO value (experimental value 3.8% and theoretical value 4.00%).

### Stage 2—Partial End-Capping of the Polyurethane Prepolymer

Component 6 was added to the reactor through a pressure equalizing dropping funnel, followed by Component 7 (slight exotherm observed). The reactor was then maintained at 95° C. for a further 60 minutes. A sample was extracted for NCO determination via titration. The extent of end-capping was 7.5%.

### Stage 3—Chain Extending the Partially End-Capped Polyurethane Prepolymer

The partially end-capped polyurethane prepolymer arising from stage 2 (220.4 g, 75-80° C.) was then dispersed into a three litre baffled round-bottomed reactor containing components 8, 9 and 10 (temperature of 25° C.). Agitation was maintained throughout the addition and for several hours afterwards. The temperature during the dispersion of the prepolymer is kept <40° C. by the use of an external ice bath. After ensuring that the pH was in the range 8 to 9, the mixture was filtered through a 52 micron cloth to give the desired water-dissipatable polyurethane having a pH of 8.82, a solids content of 22.74%.

The desired water-dissipatable polyurethane comprised the residues of DMPA (14.44%), PPG 1000 (34.55%), IPDI (47.28%), TPGME (2.07%) and EDA (1.66%). The molecular weight of the desired water-dissipatable polyurethane was determined by gel permeation chromatography and had Mw=30,100 and Mn=17,100.

### EXAMPLE 5

The following ingredients were used in this example:

| | | | | | Weight | | Weight |
|---|---|---|---|---|---|---|---|
| | | | | | percent | | percent |
| | component | abbreviation | functionality | mol wt | (Solids) | Lab scale/g | (total) |
| 1 | Polypropylene | PPG1000 | 2 | 1000 | 34.49 | 107.67 | 7.71 |
| | glycol 1000 | | | | | | |
| 2 | Dimethylol | DMPA | 2 | 134.13 | 14.42 | 45.00 | 3.22 |
| | propionic acid | | | | | | |
| 3 | Tri(propylene | TPGME | 1 | 206.29 | 2.08 | 6.46 | 0.46 |
| | glycol) mono | | | | | | |
| | methyl ether | | | | | | |
| 4 | Tetramethylene | Sulfolane | | | — | 161.54 | 11.56 |
| | Sulfone | | | | | | |
| 5 | Isophorone | IPDI | 2 | 222.29 | 47.19 | 147.33 | 10.54 |
| | diisocyanate | | | | | | |
| 6 | Tin Octoate | Tin Octoate | | | — | 0.04 | — |
| | (Jeffcat T9) | | | | | | |
| 7 | Ethylene Diamine | EDA | 2 | 60.1 | 1.82 | 5.2370 | 0.37 |
| 8 | Aq Potassium | Aq KOH | | | — | 190.23 | 13.62 |
| | Hydroxide (10%) | | | | | | |
| 9 | Deionised water | | | | — | 733.73 | 52.52 |
| | Totals | | | | 100.00 | | 100.00 |

### Stage 1—Preparation of a Polyurethane Prepolymer

A one litre round-bottomed reactor was fitted with a mechanical paddle stirrer, thermocouple and a water-cooled condenser. The following steps were performed under a nitrogen blanket.

Components 1, 2 3 and 4 were charged to the reactor at 19-22° C., followed by component 5, which was added with stirring. The reactor was heated by an external isomantal to 47-50° C. for about 10 minutes whilst maintaining a nitrogen blanket. Component 6 was then added. The reaction mixture was then warmed to 95° C. over about 5 minutes. At 95° C. an exotherm is observed and this is controlled using an external ice bath. The reactor was then maintained at 95° C. for a further two hours after which a sample was removed for NCO determination via titration to check complete reaction by comparing theoretical with experimental NCO value (experimental value 3.40% and theoretical value 3.66%). The extent of end-capping was 7.5%.

### Stage 2—Chain Extending the Partially End-Capped Polyurethane Prepolymer

The partially end-capped polyurethane prepolymer arising from stage 1 (431.0, 75-80° C.) was then dispersed into a three litre baffled round-bottomed reactor containing components 7, 8 and 9 (temperature of 250° C.). Agitation was maintained throughout the addition and for several hours afterwards. The temperature during the dispersion of the prepolymer is kept <40° C. by the use of an external ice bath. After ensuring that the pH was in the range 8 to 9, the mixture was filtered through a 52 micron cloth to give the desired water-dissipatable polyurethane having a pH of 8.81, a solids content of 22.38%.

The desired water-dissipatable polyurethane comprised the residues of DMPA (14.42%), PPG 1000 (34.49%), IPDI (47.19%), TPGME (2.08%) and EDA (1.82%).

The molecular weight of the desired water-dissipatable polyurethane was determined by gel permeation chromatography and had Mw=119,000 and Mn=34,700.

### EXAMPLE 6

### (Catalyst-Free Example)

The following ingredients were used in this example:

| | | | | | Weight | | Weight |
|---|---|---|---|---|---|---|---|
| | | | | | percent | | percent |
| | component | abbreviation | functionality | mol wt | (Solids) | Lab scale/g | (total) |
| 1 | Polypropylene | PPG1000 | 2 | 1000 | 34.55 | 215.34 | 7.66 |
| | glycol 1000 | | | | | | |
| 2 | Dimethylol | DMPA | 2 | 134.13 | 14.44 | 90 | 3.20 |
| | propionic acid | | | | | | |
| 3 | Tetramethylene | Sulfolane | | | — | 323.08 | 11.49 |
| | Sulfone | | | | | | |
| 4 | Isophorone | IPDI | 2 | 222.29 | 47.28 | 294.66 | 10.48 |
| | diisocyanate | | | | | | |
| 5 | Tri(propylene | TPGME | 1 | 206.29 | 2.07 | 12.86 | 0.46 |
| | glycol) mono | | | | | | |
| | methyl ether | | | | | | |
| 6 | Ethylene Diamine | EDA | 2 | 60.1 | 1.66 | 9.6373 | 0.34 |
| 7 | Aq Potassium | Aq KOH | | | — | 384.94 | 13.69 |
| | Hydroxide (10%) | | | | | | |
| 8 | Deionised water | | | | — | 1481.24 | 52.68 |
| | Totals | | | | 100.00 | | 100 |

### Stage 1—Preparation of a Polyurethane Prepolymer

A one litre round-bottomed reactor was fitted with a mechanical paddle stirrer, thermocouple and a water-cooled condenser. The following steps were performed under a nitrogen blanket.

Components 1, 2 and 3 were charged to the reactor at 19-22° C., followed by component 4, which was added with stirring. The reaction mixture was then warmed to 95° C. over about 10 minutes using an external isomantal whilst maintaining a nitrogen blanket. At 95° C. an exotherm is observed and this is controlled using an external ice bath. The reactor was then maintained at 95° C. for a further two hours after which a sample was removed for NCO determination via titration to check complete reaction by comparing theoretical with experimental NCO value (experimental value 3.8% and theoretical value 4.00%).

### Stage 2—Partial End-Capping of the Polyurethane Prepolymer

Component 5 was added to the reactor through a pressure equalizing dropping funnel. The reactor was then maintained at 95° C. for a further 60 minutes. A sample was extracted for NCO determination via titration. The extent of end-capping was 7.5%.

### Stage 3—Chain Extending the Partially End-Capped Polyurethane Prepolymer

The partially end-capped polyurethane prepolymer arising from stage 2 (871.3 g, 75-80° C.) was then dispersed into a 10 litre baffled round-bottomed reactor containing components 6, 7 and 8 (temperature of 25° C.). Agitation was maintained throughout the addition and for several hours afterwards. The temperature during the dispersion of the prepolymer is kept <40° C. by the use of an external ice bath. After ensuring that the pH was in the range 8 to 9, the mixture was filtered through a 52 micron cloth to give the desired water-dissipatable polyurethane having a pH of 8.32, a solids content of 22.05%

The desired water-dissipatable polyurethane comprised the residues of DMPA (14.44%), PPG 1000 (34.55%), IPDI (47.28%), TPGME (2.07%) and EDA (1.66%).

The molecular weight of the desired water-dissipatable polyurethane was determined by gel permeation chromatography and had Mw=158,700 and Mn=36,600.

### EXAMPLE 7

Inks containing each of the polymers obtained from Examples 1 to 6 were found to have good jettability when fired from piezo ink jet printers.

The polyurethanes resulting from Examples 1 to 6 may be incorporated into an inkjet printing ink in an analogous manner to the polyurethanes described in U.S. Pat. No. 6,908,185 and International patent application WO 99/50364, optionally without the water-immiscible solvent described therein.

The polyurethane of Example 6 was particularly useful for inks to be used in thermal ink jet printers due to the avoidance of metal contamination frorm metal-containing catalyst.

1.-20. (canceled)

21. An ink comprising 0.1 wt % to 10 wt % of a polyurethane obtained by a process comprising the preparation of a water-dissipatable polyurethane comprising preparation of a polyurethane prepolymer, reacting the polyurethane prepolymer with a mono functional end-capping agent to give a partially end capped polyurethane prepolymer and chain extending the partially end capped polyurethane prepolymer to give the water-dissipatable polyurethane.

22. An ink according to claim 21 which has a viscosity at 25° C. of less than 50 cP

23. An ink according to claim 21 for ink jet printing which contains water and organic solvent and has a viscosity at 25° C. of less than 50 cP.

24. An ink according to claim 21 wherein the partially end capped polyurethane prepolymer is prepared by reacting polyurethane prepolymer having isocyanate end groups with a mono alcohol.

25. An ink according to claim 21 wherein the water-dissipatable polyurethane contains from 10 to 40% by weight of poly(alkylene oxide) groups.

26. An ink according to claim 21 which further comprises a pigment.

27. An ink according to any one claims 21 to 26 which is suitable for use in ink jet printing.

28. A process for the preparation of a polyurethane comprising the preparation of a polyurethane prepolymer, reacting a polyurethane prepolymer having isocyanate end groups with a mono functional end-capping agent which is a mono alcohol to give a partially end capped polyurethane prepolymer and chain extending the partially end capped polyurethane prepolymer to give the water-dissipatable polyurethane.

29. A process according to claim 28 wherein the water-dissipatable polyurethane contains from 10 to 40% by weight of poly(alkylene oxide) groups.

30. A process according to claim 28 wherein the water-dissipatable polyurethane has an acid value>20 mg KOH/g and <100 mg KOH/g.

31. A process according to claim 28 wherein the mono alcohol is a C₁₋₆-mono alcohol or a C₁₋₆-alkyl ether of a glycol.

32. A process according to claim 28 wherein the water-dissipatable polyurethane contains from 10 to 40% by weight of poly(alkylene oxide) groups.

33. A process according to claim 28 wherein:
(a) the chain extension is performed using a C₂₋₄-alkylene diamine;
(b) the end capping is performed in tetramethyl sulpholane using a polyalkylene glycol mono C₁₋₄-alkyl ether having a molecular weight below 300;
(c) the polyol is a polypropylene glycol having an Mn of 500 to 3000;
(d) the polyisocyanate is isophorone diisocyanate; and
(e) the water-dissipatable polymer has an Mn below 10,000, an acid value>20 mg KOH/g and <100 mg KOH/g and a log P of −0.5 to +2.0.

34. A water-dissipatable polyurethane obtained by a process according to any one of claims 28-33.
